(19) United States
(12) Patent Application Publication
(10) Pub. No.: US 2015/0160023 A1
(43) Pub. Date: Jun. 11, 2015

(54) Personalized Traffic Alerts

(71) Applicants: Samir Goel, San Francisco, CA (US); Ravi Jain, Palo Alto, CA (US)

(72) Inventors: Samir Goel, San Francisco, CA (US); Ravi Jain, Palo Alto, CA (US)

(73) Assignee: Google Inc., Mountain View, CA (US)

(21) Appl. No.: 12/255,567

(22) Filed: Oct. 21, 2008

(51) Int. Cl. G01C 21/00; G01C 21/34; G06F 19/00

(52) U.S. Cl. CPC G01C 21/34

(57) ABSTRACT

Various aspects can be implemented to provide personalized traffic alerts. In general, one aspect can be a method that includes identifying, at a computing device, an area of interest associated with information request. The method also includes submitting to a remote computing system a request associated with the area of interest that does not identify the area of interest. The method further includes receiving, in response to the submitted request, a result corresponding to a super-area that is larger than, but includes, the area of interest. The method additionally includes identifying information within the result corresponding to the area of interest. Other implementations of this aspect include corresponding systems, apparatus, and computer program products.

### TECHNICAL FIELD

This disclosure generally relates to providing personalized traffic alerts or other position-related or multi-dimensional information to a user while preserving her location privacy.

### BACKGROUND

Technology has made what is already a fast-paced world even faster, with people using technology to communicate instantly and continuously, next-day delivery a common occurrence, and with the immediate availability of online data. However, traffic in most metropolitan areas continues to worsen. Traffic congestion can cause economic costs in terms of foregone productivity, wasted fuel, and a reduced quality of life.

People develop ad hoc solutions to the traffic problem. Some leave for work early or late to avoid traffic. Others develop short-cuts or other alternative routes to by-pass areas of congested traffic. Such a process is generally approached via a trial-and-error process, as a commuter tries various routes until she finds one that seems to be the quickest. However it is difficult for her to draw any general conclusions about relative congestion on different routes because of non-recurring congestion events like accidents. It is possible to check traffic reports before leaving and to monitor the radio or road-side signs for clues to traffic problems. In addition, certain wireless services can provide indications of real-time traffic speed graphically on a road map (such as by showing different-colored arrows on roads to indicate approximate traffic speed).

### SUMMARY

This specification describes various aspects relating to providing information responsive to a user's location without the user having to provide their actual location, or provide only their actual location. In order to be able to provide meaningful information, a system for providing traffic information needs information about location of interest for a user. However location of interest may be closely correlated to the user's current location. This would be true, for example, when user is continuously monitoring traffic information along the route she is currently driving. Hence, simply asking for relevant traffic information exposes user's location to the system.

More generally, this document discusses techniques by which a user's computing device presents a central service with information in addition to, or that is broader than, the information on which the user is actually focused. The service may return results for both the relevant request and the non-relevant requests, and the user's device may sort the wheat from the chaff upon receiving a response from the service.

In one particular application discussed here, a personalized traffic alert may be provided to a user while preserving the user's location privacy. The user's client device may report multiple points or a zone for the user's position so that a remote service may not readily determine the user's precise location. The service may generate results that apply to the provided multiple points or zone, and the user's device may then select the result or results that are applicable to their particular location. In this manner, a user may obtain results for a particular location without having to plainly disclose that location to a service. This may have particular advantage for users who are concerned about their privacy.

In general, one aspect can be a method that includes identifying, at a computing device, an area of interest associated with information request. The method also includes submitting to a remote computing system a request associated with the area of interest that does not identify the area of interest. The method further includes receiving, in response to the submitted request, a result corresponding to a super-area that is larger than, but includes, the area of interest. The method additionally includes identifying information within the result corresponding to the area of interest. Other implementations of this aspect include corresponding systems, apparatus, and computer program products.

Another general aspect can be a system for providing personalized traffic alert that includes a client device configured to identify an area of interest associated with information request. The system also includes means for generating a super-area that includes the area of interest and provides privacy with respect to the area of interest. The system further includes a server configured to receive requests from the client device based on the super-area, and provide up-to-date traffic information for the super-area.

These and other general aspects can optionally include one or more of the following specific aspects. The method can also include gathering, by the computing device, route information corresponding to a travel pattern over a period of time. The method can further include determining a current route of travel including a predicted final destination based, at least in part, on the gathered route information. The method can additionally include providing a traffic alert associated with the current route of travel based on the identified information.

The information request can be request for traffic information. The area and the super-area can be a geographic area. The area and the super-area can be two-dimensional areas. The super-area can be a geographical area chosen and reconfigurable based on a user-specified privacy setting. The step of submitting the request can be submitting a request for real-time traffic information. The computing device can be a wireless device running a software application. The step of receiving can be receiving traffic alert information by the computing device via a wireless communications link. The step of identifying information can be filtering the result for relevant traffic information associated with the area of interest.

The route information corresponding to a travel pattern over a period of time can be gathered automatically. The current route of travel can be a current location of the computing device and a route from the current location to the predicted final destination. The area of interest can be the current route of travel. The current route of travel can include a primary route and a secondary route. The primary route can be a route most frequently traveled by a user. The secondary route can be one or more meaningful alternate routes that a user takes when there is traffic congestion on the primary route.

Particular aspects can be implemented to realize one or more of the following advantages. A personalized traffic alert system can report the traffic events of interest to the user by alerting a user to traffic congestions along her current travel route. Personalized traffic alerts can be delivered to the user's wireless device (e.g. cellular phone) or via other media, such as email, SMS, pager, and the like. Minimum input from the user is required because the system can automatically learn the routes (and detours) taken by the user.

Additionally, the personalized traffic alert system can operate without compromising a user's location privacy. Information that can identify a user's location at a given point in time can be safeguarded in order to preserve the user's privacy. The traffic alert system can also preserve the user's location privacy at various levels based on the user's privacy preference. For example, the user can configure the system to reveal location information at varying levels of granularity (thereby improving system operation or permitting targeted advertising, supplementary services, etc.) in exchange for inducements like free or reduced service cost.

The general and specific aspects can be implemented using a system, method, or a computer program, or any combination of systems, methods, and computer programs. The details of one or more implementations are set forth in the accompanying drawings and the description below. Other features, aspects, and advantages will be apparent from the description, the drawings, and the claims.

### DESCRIPTION OF DRAWINGS

These and other aspects will now be described in detail with reference to the following drawings.

FIG. 1 is a conceptual diagram of a process that analyzes user travel routes and generates personalized traffic alerts while preserving the user's location privacy.

FIG. 2 is a schematic diagram of a system for providing personalized traffic alerts.

FIG. 3 is a client-server flow chart illustrating a process for providing personalized traffic alerts.

FIG. 4 is a flow chart illustrating a process of how the client automatically learns a user's travel routes.

FIG. 5 is a flow chart illustrating a process of how the client automatically predicts the user's current travel route.

FIG. 6A is a flow chart illustrating a process for guarding a user's location privacy by generating a super-area that includes the area of interest.

FIG. 6B shows an example of the super-area based on the rectangular calculation.

FIG. 7 is a block diagram of computing devices and systems.

Like reference symbols in the various drawings indicate like elements.

### DETAILED DESCRIPTION

The systems and techniques described here relate to providing users with information in response to user requests, in ways that let the users preserve a desired degree of privacy. In particular, users may submit queries that relate to the information in which they have an interest in addition to other information. A service that receives such a request may have a difficult time sorting the information relevant to the user from the other information. As a result, the user may be given a degree of privacy. The service may thus prepare a response that covers both the relevant and the extraneous portions of the request. The user's device may then discard the responses to the extraneous requests (or the extraneous portion of a common response), and may use the responses to the relevant requests (or the relevant portion of a single response).

In the example pictured here, the techniques relate to providing personalized traffic alerts to users, such as commuters and other travelers, typically traveling by automobile, truck, or mass transit. The systems can take many forms, including personal communicators, personal computers, and vehicle navigation systems. The data can also be entered in many forms, including by telephone keypad and voice. In general, the systems operate by gathering a user's travel routes over time and predicting the user's current travel route based on a travel profile for the user. The systems also access real-time traffic data for a random generalized area in order to preserve the user's location privacy. Further, the systems provide the user with an up-to-date traffic alert for the user's current travel route, and alternate routes that avoid the congestion points.

Advantageously, the systems and techniques can let travelers receive personalized traffic alerts that are both current and relevant. They are current because they reflects real-time traffic conditions. They are relevant because they can provide directions that address the particular user's travel plan. Yet they can do so without requiring that the user enter in specific information about the travel plan. In addition to the current travel route, traffic flow information for alternate routes can be monitored or obtained. For example, static information about traffic flow, such as the typical speed on a residential street (for which actual real-time information is not available) can also represent the transportation flow on that street. Apart from transportation flow in vehicles, other transportation flows such as that involved with rail, ferry, and light rail can also be obtained. Additionally, the personalized traffic alerts can be provided to the user without compromising the user's location privacy.

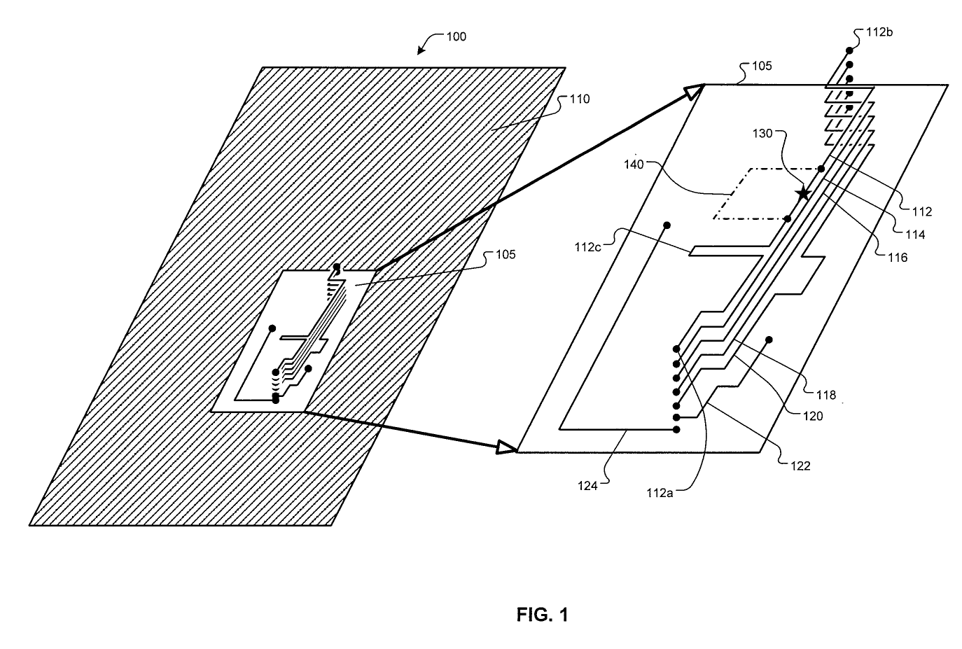

FIG. 1 is a conceptual diagram of a process that analyzes user travel routes and generates personalized traffic alerts while preserving the user's location privacy. The diagram shows a perspective view of a general area 100, which includes a travel zone 105 and a dummy area 110. The travel zone 105 represents an area of interest in which a user typically travels, such as the area between and around the user's home and workplace. The dummy area 110 is used to mask the area of interest and provide location privacy. Thus, an intrusive third-party may know that the user is somewhere within the general area 100, but would not know the exact location of the user within the travel zone 105.

The size of the general area 100 (or the dummy area 110) can be varied based on the user's desired privacy preference. For example, the general area 100 can be a much larger geographical region than the travel zone 105. In some implementations, however, the general area 100 can be the same as the travel zone 105. The travel zone 105 may also be smaller and include just the area around the user's current position, and the dummy area 110 may include an area somewhat larger than that travel zone, e.g., so that both areas are narrower even than the general area 100 shown in FIG. 1. Also, although the areas 105, 110 are shown in the figure as fully overlapping, the travel zone 105 may only partially overlap with the dummy area 110. In such a situation, multiple requests may be provided to a service, with one request applying to an area in which the travel zone 105 overlaps with one dummy area, and another applying to an area in which the travel zone 105 overlaps with another dummy area. Results may be obtained for both zones and may be combined by a user's device, so as to provide even more privacy.

Also, although the areas are shown here as rectangular in shape, they may also take other appropriate shapes such as circles having a particular radius. Moreover, the area for information may be other than geographic areas or even spatial areas, such as where data stored in a multidimensional structure is to be queried, with results provided thereto. In addition, the travel zone 105 or other area that focuses on a user's needs, and the dummy area 100 need not be centered relative to each other. By varying the relative sizes, shapes, and/or positions of the areas, additional privacy may be achieved.

Traffic information within the general area 100 is used to provide personalized traffic alerts to a user. The level of detail in traffic information can be a function (e.g., linear function) of the size of the general area 100. For example, if the general area 100 is much larger than the actual travel zone 105, the level of detail provided can be somewhat coarse, e.g., traffic information for the congestion points on major highways. On the other hand, if the general area 100 is relatively small, the level of detail provided can be greater, e.g., traffic information for the congestion points on streets as well as highways. In this manner, the bandwidth requirement can be minimized without sacrificing the user's location privacy. In such a situation, the level of privacy provided may be increased by increasing the relative size of the dummy area 110, but such an increase may result in the requirement to provide additional data that will not be used or to reduce the granularity of the data that is provided.

Users (e.g., travelers or car drivers) can be broadly classified for this example into two categories: regular commuters and others (e.g., tourists, etc). The traveling pattern of a regular commuter can be highly predictable—there are only a few travel routes that a user frequently takes. For example, when traveling between home and office, a user typically uses one of a few distinct routes, with occasional diversions to make purchases or run errands. A significant number of users are regular commuters. For such users, the experience of monitoring traffic can be greatly simplified by auto-learning their travel route preferences and providing personalized traffic alerts once they are on a certain route.

The travel zone 105 can be most conveniently represented as a two-dimensional map, on which routes can be overlaid. As shown in FIG. 1, layered on top of travel zone 105 are a number of user travel routes 112-124, each of which represents a route that has been traveled by a user. Data for the routes 112-124 can be gathered in any appropriate manner. For example, global positioning system (GPS) data can be collected, such as by a cellular telephone, personal digital assistant (PDA), automotive navigation device, or other such device. The route data can be collected, for example, by sampling position data at set intervals such as every fifteen seconds, or at another interval. In addition, the position data can be recorded at set location intervals, with the elapsed time between positions representing the rate of change in position. The data can also be generated from radiolocation (e.g., trilateration between base stations) in a cellular telephone system or other appropriate methods.

The data collection can be instituted in a number of ways. As an example, a user may place a device such as a cellular telephone, PDA, or navigation system into an “auto-learn mode,” such as by selecting an appropriate menu choice in a graphical user interface. A tracking system can then be activated whenever, during the learning period, the device is substantially moved, so as to indicate that the user is making a trip in her vehicle. For many travelers, such activity would occur in the morning and the evening during typical commute periods.

The learning period can be a definite or an indefinite period. For example, the device can be programmed to capture data for one week and then stop capturing data. Alternatively, data can be gathered until a recurring pattern begins to show in the data. In such an approach, a minimum collection period, such as one week, can be set so that the system does not stop gathering data simply because, by coincidence, two days in a row involved similar routes. Where the period is indefinite, the system can, for example, continue gathering data so as to update the information continuously, so that predictions of future routes can be made more readily. Such an approach can therefore allow the predicted routes to change as the user changes, such as when the user begins stopping at a day care center every weekday, and thus adds a detour to the user's previous path to work.

Each of the travel routes 112-124 represents a particular path taken by the user. The pictured travel routes 112-124 can be a subset of all routes taken by the user during the learning period, and can be selected as all trips during a particular time of day, such as during the morning commute time. Routes for other times can be handled together as a distinct group. In addition, routes that are unlike any others, and that are not repeated, can be treated as an outlier and can be discarded, or simply saved in memory (e.g., as part of a “recently visited” list), but not used to predict future routes.

Each travel route can have a number of identifying characteristics. By way of example, route 112 has a start point 112a, an end point 112b, and a stop point 112c. The start point and end point for a trip can be inferred by identifying locations for which there are long periods of immobility connected by a period or periods of mobility (e.g., with short periods of immobility representing stops during a trip or stoplights). Stop points can be inferred from shorter periods of inactivity (i.e., on the order of several minutes, or long enough to avoid counting a stop at a stoplight as a false positive, but short enough to prevent a stop for coffee or day care drop-off from being a false negative) that have activity on each side.

Also, start, end, and stop points can be entered manually. For example, a user may press a key on a navigation device when they arrive at an important point along a route so as to identify that point as a stop point through which they would like to travel. Thus, for example, when training a navigation device, the person may press the key when passing a coffee shop if they want to always pass the coffee shop, regardless of whether they stop at the shop during the training period. Such manual stop point entry can have the benefit of allowing for faster training of a navigation device, and can also allow a user to provide preferences explicitly.

As another example, a user may prefer to take a particular bridge to work regardless of what real-time traffic data can indicate, because the user is more familiar with this route compared to alternate routes (or knows how to “beat” the traffic for the route). Alternatively, the user may start by finding directions using software such as Google Maps for Mobile and then ask the application to alert her for traffic congestion along that route.

The start point and end point can also be adjusted to simplify a travel route. For example, it can be impractical to provide more than one route near each end of a travel route. That is because there can be only one logical path out of a user's residential neighborhood (and no traffic in the neighborhood). The user might also be required to weave through a large parking lot at work—another area in which navigational advice is not helpful. Thus, the start point and end point, for purposes of computing a suggested route, can be shifted so as to bypass such problems at each end of a trip.

Other points along a travel route can also be adjusted to match a known street or other travel path. For example, where a street contains multiple lanes, any location information for a travel route can be resolved to a single location for that street. Also, locations in parking lots or other similar locations can be resolved to a single point. In this manner, small and irrelevant variations from one travel route to another can be eliminated.

Each travel route represents a trip at a certain time, such as a daily morning commute over the course of a week or more. Thus, by example, travel route 112 represents a morning commute on a Monday morning, and shows a trip from the user's home to the user's office with a stop in the middle of the commute. That stop can represent, for example, the retrieval of a cup of espresso needed by the user to get the week started on the right foot. Travel route 114 represents the Tuesday morning commute, with no stops, as the user anticipates the amount of work still needed to be completed for the week. The Wednesday travel route 116 is similar to the Tuesday travel route 114. The Thursday travel route 18 also involves a stop, but this time to drop off clothes at a cleaner. Finally, the Friday travel route 120 involves a slight detour and stop for the user to follow through on a weekly bagel pick-up for the user's colleagues and office staff.

Travel routes 122, 124 are trips on the weekend. Travel route 122 shows a trip to swimming lessons for the user's young child, and is a weekly trip, at least for a dozen lessons or so. Travel route 124 is a trip to a football game, and typically occurs on a Sunday but only when the team is “home.” However, from week to week, the end point for the trip varies as the user selects a different parking area for each game. In addition to the routes shown in FIG. 1, other routes can also be gathered, such as those taken during the evening commute.

Upon gathering travel routes over a particular time period, expected travel routes for the future can be generated and personalized traffic alerts for those expected routes can be provided. As an example, suppose that a user is commuting to work on Monday morning, via travel route 112. Before obtaining traffic information from a remote server, the general area 100 can be generated by the user's client device in order to protect the user's location privacy. The general area 100 includes the current route 112 that the user is traveling on, and encompasses an area large enough without compromising user's location. For privacy protection, the general area 100 can be randomly chosen (but to include the travel zone 105) to prevent an entity at the server from obtaining precise location of the user.

On this day, traffic is particularly bad around a congestion point 130 on travel route 112. Well before the user approaches the congestion point 130, the client device can provide a traffic alert to the user. The traffic alert can contain relevant traffic information, such as the average vehicle speed, the location and extent of the congestion, and the like. Based on the traffic alert, the user can then make an intelligent decision on whether to take an alternate route. Here, the user decides to take the alternate route 140 in order to avoid the traffic congestion.

Once the user decides to take the alternate route 140 as a detour, the user's client device can gather information for the alternate route 140. Thus, in the future when the user encounters a traffic congestion around the congestion point 130, the client device can provide traffic alert for both the travel route 112 and the alternate route 140. This way, the user is even better informed as to whether taking the alternate route 140 would save her valuable time.

If the user decides to take another alternate route (not shown) other than route 140 as a detour, the user's client device can also gather information for such alternate route. Thus, in the future when the user encounters a traffic congestion around the congestion point 130, the client device can provide traffic alert for the travel route 112 and the alternate route 140, as well as the additional alternate route. In some implementations, the client device can monitor traffic on both alternate routes and provide the user with a recommendation as to which alternate route would be better to take.

As discussed above, when the user is seeking traffic information for an area, and when the user's device is reporting information about its location to help build a travel profile (when such action involves interaction with a remote server), the user's device may make queries on areas larger than the travel zone 105, such as for the general area 100 that also includes the dummy area 110. When traffic data or other data for the general area 100 is returned by the remote server, the user's device may extract only information relevant to travel zone 105, and may discard the other returned data.

For example, the data may include map tiles for a particular area that are supplemented with meta-data about current traffic conditions for areas represented by the map. A request may be made to a remote server by submitting a bounding box for a map, and the client device may purposefully draw the bounding box too large, and off-center, so as to obtain map tiles and traffic condition indicators (e.g., colored arrows overlaid on the map tiles) for a much larger area that includes areas to which the user does not intend to travel. As a result, any intruder who obtains such information may have a much harder time trying to locate the user with any degree of success.

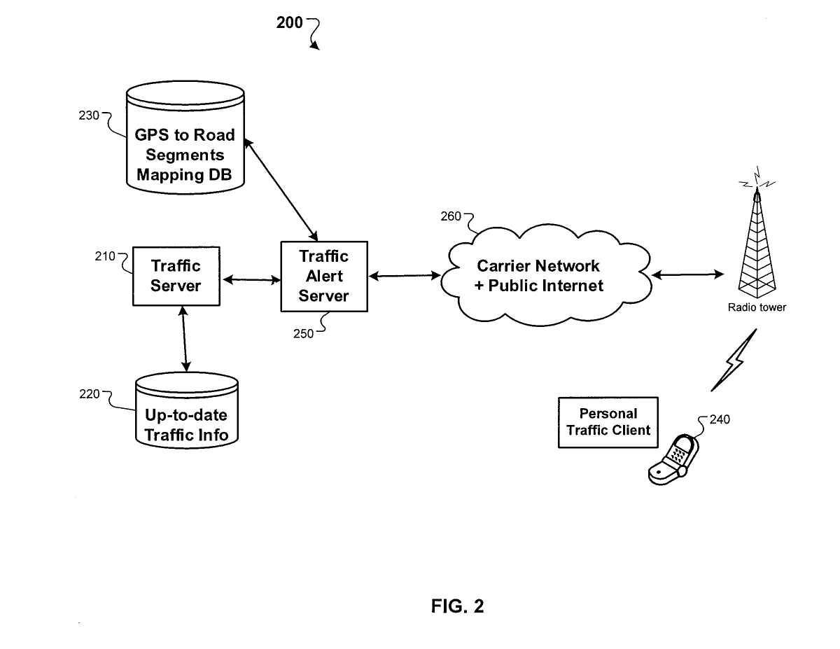

FIG. 2 is a schematic diagram of a traffic alert system 200 for providing personalized traffic alerts. Traffic alert system 200 includes a traffic server 210, which maintains up-to-date traffic information 220 collected from various sources (e.g., taxi fleets, ground sensors, mobile devices, etc). Traffic alert system 200 also includes a GPS-to-road segment mapping database 230, which contains the information necessary to translate GPS data (e.g., location coordinates) of a mobile device to the road segment identifier (ID) that the mobile device is traveling on.

As an example, an entire highway system (e.g., Highway 101) can be divided into small road segments. Each road segment can be the portion of the highway between two exits. Each of the road segment has a corresponding unique road segment ID. Thus, using the data contained in the mapping database 230, GPS coordinates can be translated into a particular road segment of a highway that the user is traveling on.

Traffic alert system 200 further includes a personal traffic client 240, which can be a software application running on a mobile device 245, such as a cellular telephone, a PDA, and the like. As an example, personal traffic client 240 can determine a user's location using either GPS or radiolocation through cell-tower trilateration. As will be discussed in detail below, personal traffic client 240 can perform all the functions necessary to gather user's travel routes, predict user's current route, obtain traffic information for the current route, and generate a traffic alert if there is a traffic congestion on the current route. Personal traffic client 240 may also interact with a remote service, such as a service provided by traffic alert server 250 to provide such functionality.

In one implementation, personal traffic client 240 operates by communicating with the traffic alert server 250 through a wireless carrier network and the Internet network 260. Traffic alert server 250 acts as the interface to the backend traffic monitoring system with which personal traffic client 240 communicates to obtain the traffic information it needs. As a result, personal traffic client 240 can offer various functionality to a user including 1) automatically learning travel routes (and detours) that are frequented by a user; 2) predicting the current route that a user is going to take based on past travel history; 3) monitoring the traffic on the user's predicted current route; 4) alerting the user only when a traffic event is detected on the road segments that a user is expected to travel; 5) recommending “meaningful” alternate routes to the user to avoid congestion.

As mentioned above, because traffic alert system 200 can auto-learn and store a user's travel routes, its implications on user's privacy need to be considered. Given the sensitivity associated with providing location information for a user, it is desirable for the system to protect the location privacy of the user.

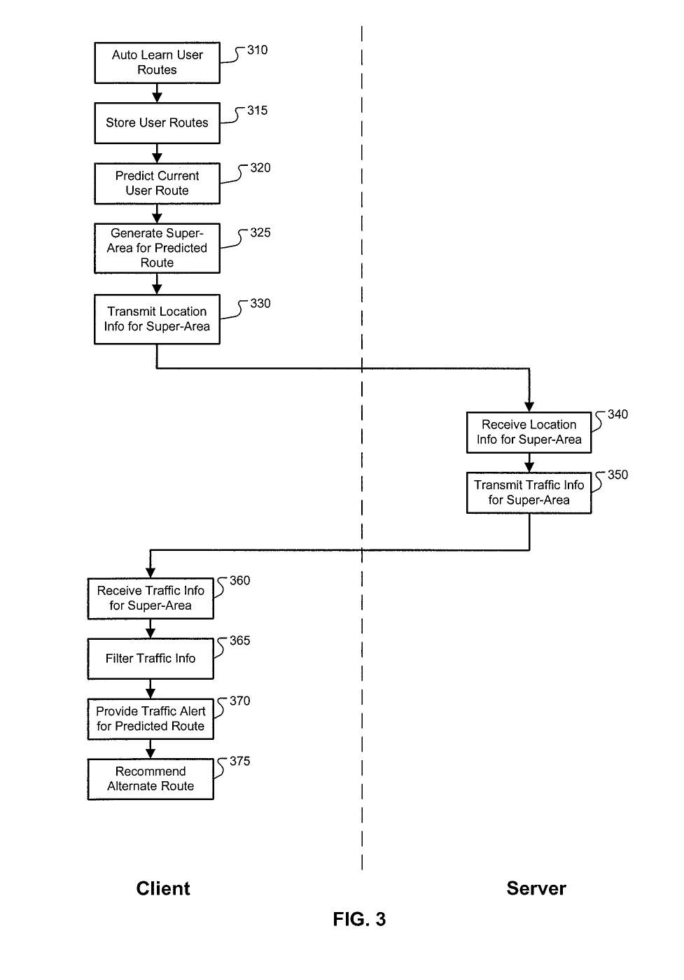

FIG. 3 is a client-server flow chart illustrating a process for providing personalized traffic alerts to users. In general, the illustrated process involves generating predictive routes for a user (user routes) and obtaining traffic information for an area around the user's expected travel that is larger than an area needed to provide coverage for the user's path—a super-area. In the process, the server provides results for the super-area, and the client filters the relevant results out of the results for the super-area.

In the example, a user route is a travel route the user has previously taken, and is similar to the routes discussed above with respect to FIG. 1. The current user route is the route on which a user is currently traveling or is about to travel, and can include the start point, end point, and any other stopping points in between. A super-area (similar to the general area of FIG. 1) is an area that encompasses the predicted current user route. The size of the super-area can be variable based on the user's privacy preference.

Location information of the super-area is the relevant information needed to query the server, and would include, for example, the geographical boundary of the super-area and highways and streets within the super-area. The alternate route is a viable route that the user can take if there is traffic congestion on the current user route. Super-area can be computed in a pseudo-random fashion. In certain implementations, for a given start and end point, a given instance of the traffic-alert application would generate the same super-area. Each instance of the application uses a potentially different random seed. This leads to a different super-area for different instances even when start/end point is the same.

In this example implementation, most of the computational burden is placed on the client (e.g., the personal traffic client as described in FIG. 1) in order to allow preservation of a user's location privacy. On the other hand, the servers (e.g., traffic alert servers and traffic servers as described in FIG. 1) maintains a database of up-to-date traffic information and provide traffic information to the client. There can be additional ways to request traffic information while preserving a user's location privacy.

In one implementation, a 2-step procedure for determining traffic information can be used. For example, in the first step, the client device sends a super-area to the server and requests information about the road-ids that have interesting traffic events. In the second step, the client device makes a sequence of requests to the server. Each request includes a subset of road-ids and asks for more detailed traffic information about those road-ids. In this manner, the sequence of requests from the client device can ensure that server cannot decipher the route that the user is planning to take. For this user not only requests information about road-ids on his route, but also about other road-ids. These dummy road-ids can be interspersed in the sequence of requests in a random fashion. In addition, a request for a road-id gives away very little route information to the server—the server can only infer that the client is going to pass thru this point, but does not know any adjacent, prior, or post road ids that would lie on the client's route.

In another implementation, a polyline method can be used to request traffic information while preserving a user's location privacy. For example, client device creates a super-area as described earlier. It then determines the highways in this super-area, and requests traffic information for long stretches of these highways. As an example, if the user is going to travel on US-101N from Mountain View to San Francisco, the client device would ask for traffic information along various stretches for highway 101N, 101S, 280S, and 280N. By restricting the request of traffic information to certain highways (instead of the entire super-area), the client device would be able to reduce the amount of data that it receives from the server. Further, it can add more confusability with requests from other users and prevent the server from determining the location of the user.

In a further implementation, a peer-to-peer method can be used to request traffic information while preserving a user's location privacy. The user can be a member of a peer affinity group, such as friends, family, or other online groups. When the client device needs information for a route it breaks the request into route segments and sends each segment to a different member of the peer affinity group that is currently online. The peer transmits the request to the server, receives the response, and relays it to the client device, which collates the information into the traffic information for the entire route.

With enough requests and peers, this mechanism can preserve privacy at the server since the server will get requests for non-contiguous and possibly widely separated route segments from each peer on behalf of multiple end users. It can also preserve privacy at the peers to some degree since each peer only learns about a single route segment that the user is interested in (unless peers collude). In addition, this approach can potentially have performance benefits as the request from the client to the server is effectively being parallelized (especially when requesting information from multiple servers). Of course, to participate in such a program the peer has to be compensated in some way, for example by direct payment from the user, or by the user agreeing to reciprocate, or by means of social recognition that the peer earns.

There have been several peer-to-peer systems for information downloading as well as communication that have been developed. An example peer-to-peer system allows clients to obtain large files as multiple segments from peers. The method described here as applied to requesting road traffic and similar information, however, differs from existing peer-to-peer systems in several respects. For example, there is no logical central server that knows which peers are servicing a particular client device. Further, the nature of the information, allowing it to be segmented and combined in multiple ways, provides better privacy from peers. In contrast, if the client device asks a peer to fetch a segment of a file on its behalf, the peer can reasonably assume the client is interested in the entire file. Finally, the real-time nature of the information means that the peer will more likely have to initiate a request to the server rather than rely on its own cache.

In other implementations, server-side proxies can be used to request traffic information while preserving a user's location privacy. In this example, the client transmits the information request to a proxy server, which cloaks the user identity and submits the request to the traffic server as if it were coming from the proxy. The proxy forwards the traffic server's response to the client. If a single proxy is used, it should be a trusted proxy server. However, as in the case of the peer to peer approach, the client device can segment its request and send it to multiple proxies. Very similar privacy and performance benefits relating to the peer-to-peer method as described above can be obtained. The difference is that typically there are fewer proxy servers than peers in the system, and their identities are static for long periods of time.

At 310, the client gathers user route information by automatically learning user routes. The routes may be learned, as discussed above, by monitoring user travel and identifying common paths, such as common paths at particular times of each day. At 315, the gathered user route information are stored by the client. At 320, current user route can be predicted using the stored user route information. For example, a day and time may be analyzed to determine the user's intent, so as to match the day and time to recorded paths on particular days (e.g., weekdays) and times (e.g., morning commute). Once the current user route is predicted, at 325, the client generates a super-area based on the predicted current user route.

At 330, the client transmits location information for the super-area and queries the server for traffic information within the super-area. The super-area may be submitted once for an entire route, or may be submitted multiple times during a trip, so as to help ensure that traffic condition data is as up-to-date as possible. For example, the relevant initial point for a user may be their home, and a normal submission may entail submitting a lat/long coordinate for the home, where the user's device is currently sitting. Under the techniques described here, the user's device may submit a number of different points, located more-or-less around the user's home, but generally scattered so as not to provide an indication of the user's location. Alternatively, a bounding box or other two-dimensional geometry that encompasses or is near to the user's home may be submitted, and the server may then provide traffic information for all roads segments inside or that pass through the bounding box.

At 340, the server receives the location information for the super-area transmitted by the client and accesses its database(s) for up-to-date traffic information. The relevant information may include traffic for areas in or near the user's travel path in addition to other areas also (e.g., for the super-area). At 350, the server responds to the client's query by transmitting traffic information within the super-area. Since the only information received from the client by the server is the location information for the super-area, the user's current travel route is not known to the server and the user's location privacy can be preserved.

At 360, the client receives traffic information for the super-area from the server. This traffic information includes relevant (i.e., user's current route) and extraneous (e.g., traffic info for another highway that is not on the current user route) traffic information. Thus, at 365, the client obtains the relevant traffic information and filters out the extraneous information. At 370, if the relevant traffic information includes points of traffic congestion, the client then issues a traffic alert to the user for the current user route. The client may also simply show map tiles with traffic information (e.g., green, yellow and red arrows) overlaid on the tiles. At 375, if information for alternate routes has been gathered by the client, traffic information for such alternate routes will also be monitored by the client and recommendations of which alternate route to take can be provided to the user.

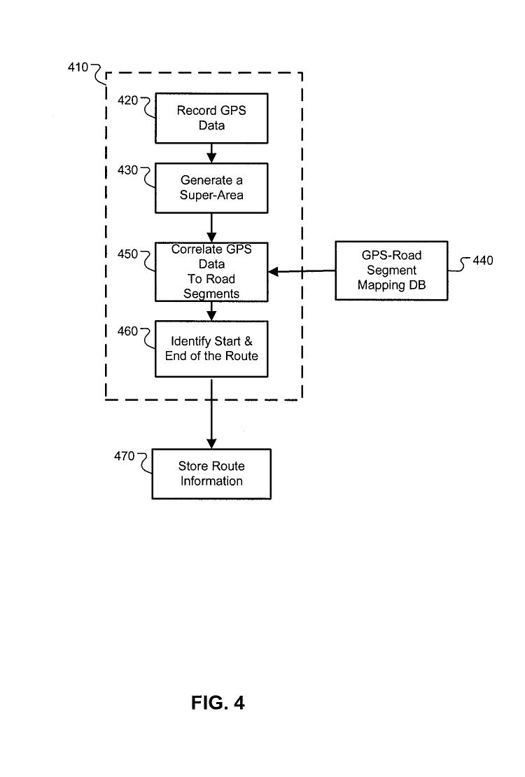

FIG. 4 is a flow chart illustrating a process of how a client automatically learns a user's travel routes. Initially, when a user starts to drive, she would activate the client, e.g., the personal traffic client application installed on her mobile device. At 410, a user's travel routes are gathered by the client. In the beginning, the client would not know anything about the travel route that the user is going to take. At 420, GPS data or coordinates of the travel route taken by the user is recorded by the client. The client can perform various types of processing based on the recorded GPS data. As an example, the client translates GPS coordinates into road segments traveled by the user by querying the server for mapping information from the GPS-to-road segment mapping database.

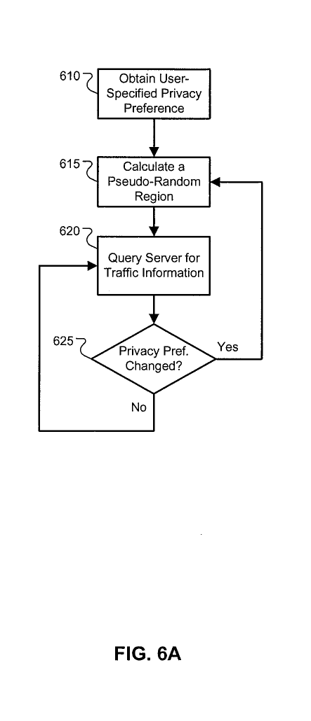

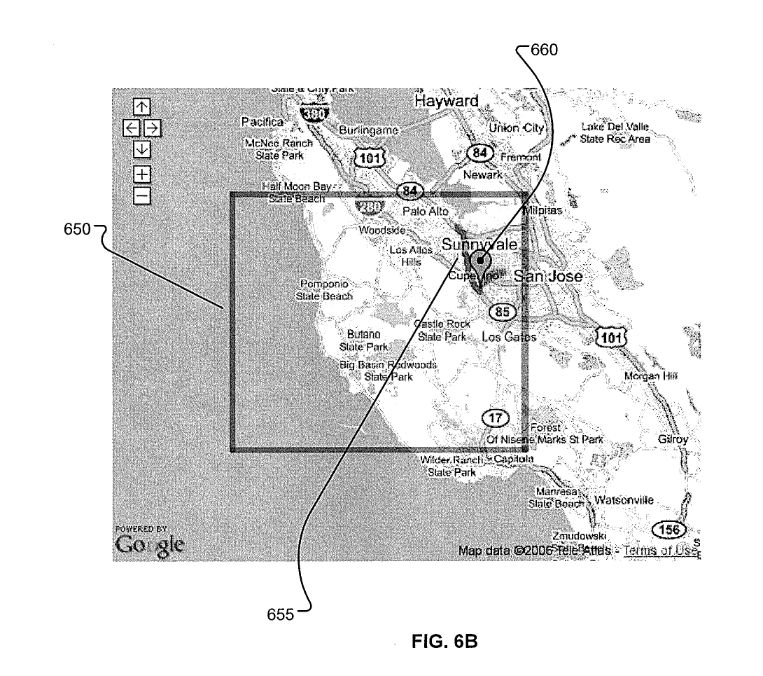

The client, at 430, generates a super-area in order to protect the user's location privacy. Exemplary implementations for generating the super-area will be discuss in detail below in relation to FIG. 6A. The super-area can be a general geographical area that includes the current route (start point to end point) that the user is traveling on, and is large enough without compromising the user's location privacy. For privacy protection, the super-area can be randomly chosen to prevent an entity at the server from obtaining a precise location of the user.

At 440, the server provides GPS-to-road segment mapping information to the client, which then at 450, correlates GPS data of the user's mobile device to road segment IDs for the current travel route that the user is traveling on. The server may alternatively make such a comparison. At 460, the start and end points of the travel route are identified by the client, e.g., based on pauses in the travel record. Also, since regular commuters take the same route multiple times, the start and end points of a travel route can be identified by examining a recent history of routes traveled by the user. At 470, the travel route information is stored in the client.

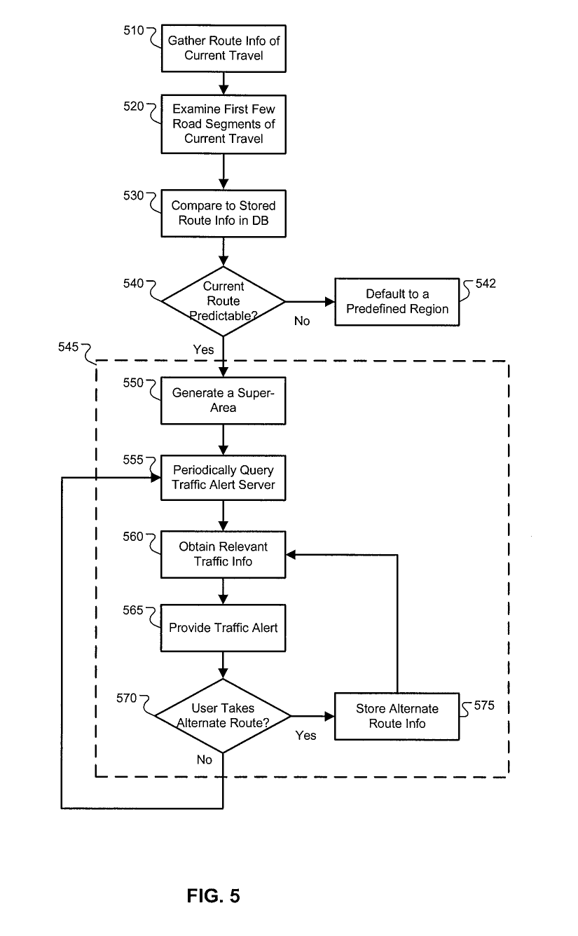

FIG. 5 is a flow chart illustrating a process of a client automatically predicting a user's current travel route. Such a process may be employed, for example, after learning various routes for a user, as explained with respect to FIG. 4. When a user starts to travel on the current travel route, at 510, the client gathers route information of the current travel route. At 520, after the first few road segments have been gathered, the client examines the first few road segments traveled. At 530, the first few road segments are compared to the history of routes frequented by the user to predict the current travel route being taken. At 540, the client determines whether the current travel route is predictable. Alternatively, the client may generate a route based on the time and day—e.g., selecting a most common observed route for the user during a morning time period on a weekday.

If the entire route cannot be predicted, at 542, the prediction defaults to a pre-defined geographic region around the user's current location. For example, the pre-defined region can be a circular region (of say, 2 miles) centered around the road segment on which the user is currently traveling. In some cases, the client can make intelligent predictions even without any prior travel route information. As an example, if a user is traveling on a highway, then the user is more likely to continue on the highway then to deviate from it. Also it is unlikely that the user would be interested in traffic information for a portion of the highway behind him. In such a case, a more intelligent prediction would be an oval region that extends along the highway (in the direction of travel) and also covers some nearby exits.

If the current travel route can be predicted, at the actions of 545, the client monitors traffic on the predicted route. At 550, the client generates a super-area based on the predicted travel route. As mentioned before and will be discuss in more detail below, the super-area is used to preserve the user's location privacy and can be a broad geographical area that encompasses the predicted travel route or a portion of the predicted travel route. The super-area can be generated in a random fashion to avoid revealing the precise location of the user.

At 555, using the generated super-area or another super-area, the client periodically queries the server for traffic information in the super-area. Where multiple super-areas are generated to account for multiple requests by a user along a route, multiple super-areas may be used, with each showing the user moving in a different direction and getting farther and farther away (at a speed that matches the traffic speed provided to the device by the system). In this manner, a user's location may not be determined simply by monitoring the general progression of super-areas identified by the client over a period of time.

The server responds with traffic information pertaining to all the road segments that fall in the super-area. At 560, the client obtains relevant traffic information along the predicted travel route by filtering out extraneous information not pertaining to the predicted travel route. It can seem that requesting information for the super-area may require the client to process a lot of traffic information. However, it is not expected to be typically the case because the client can be configured to request information about only congested road segments (i.e., road segments where current vehicle speeds are below a certain threshold), and other techniques may be used to lessen the volume of data required.

At 565, the client alerts the user upon detecting traffic congestion along the predicted travel route. This traffic alert can be based on a user-specified congestion threshold. For example, a user may specify the threshold to be when current vehicle speed is below 20 miles per hour. Once the user receives a traffic alert from the client, the user can brace herself for the traffic congestion or can elect to take an alternate route. At 570, the client determines whether the user takes an alternate route (e.g., by monitoring GPS data generated by the client device). At 575, if the user takes an alternate route, this detour information is stored by the client. On the other hand, if the user decides to stay on the predicted route despite the traffic congestion, the client would continue to periodically query the traffic alert server for an up-to-date traffic information along the predicted route.

This alternate route information can be used the next time there is traffic congestion along the same predicted route. As an example, next time the client detects traffic congestion on that predicted route, it can automatically query the server for traffic information on the alternate route. If that is also congested, the client can give both traffic alerts to the user. This way, the user can make an informed decision on whether to take the alternate route or stay on the predicted route. Additionally, over a period of time, the client can learn all the alternative routes preferred by the user, and can eventually recommend the least congested one from among them.

Because all the route information of the user is stored in the user's client device, the user may choose to upload her route-preference information by registering an account with the server. This can serve as a protection against losing route-preference information in the event that the client device is lost or stolen. This can be done in a privacy-preserving manner by simply uploading the relative probabilities associated with different routes that the user has taken in the past. The uploaded route information can be stripped off of any timing information that can identify when the user took a particular route.

Users may also want to share their route information with their friends or family because route information (including a GPS log) can probably be the best way of giving directions on how to travel from location A to location B. Once again, the route information can be stripped off of any timing information. This would allow users to share routes without the risk of indicating when they took the route.

FIG. 6A is a flow chart illustrating a process for guarding a user's location privacy by generating a super-area that includes an area of interest. Any system that can identify the location of user at a certain point in time may raise concerns among privacy-sensitive people. Just as users are willing to keep private information on their computers (in local hard drive), they likely would be willing to keep it on their mobile devices. A user's location privacy can be preserved because the GPS log resides on the mobile device. In one example, the traffic alert system keeps all the travel routes of user (and any GPS log) on the user's mobile device, and in encrypted form to preserve privacy in case the phone is lost or stolen. Keeping the travel routes and GPS log in encrypted form also allows the encrypted data to be backed up on a server for fault-tolerance and data recovery.

As indicated above, the client queries the server in order to translate the GPS coordinates to road segment IDs and to obtain traffic along the user's route. Both of these queries involve communicating the user's location which can compromise the user's location privacy. To avoid this, the client generates a super-area by approximating the user's location to a broader geographic region. As an example, the area of interest can be a section of Highway 101, and the super-area can be a relatively large area, such as the North San Francisco Bay area. Thus, an intrusive third party would not obtain the user's location at the GPS coordinate level, but would instead only know the user's location at a very coarse granularity (e.g., at a metropolitan area level).

In obtaining super-area information, the client may simply provide a point location rather than a super-area, if the client knows that the server responds with information for an area. In such a situation, the client may submit a point (e.g., a lat/long pair) that is set off a distance from the user's actual location, but close enough that map data returned by a server will include the user's predicted route. For example, the submitted point may be a mile from the user if the client knows that the server will provide mapping data for areas two miles around the submitted point. This may be another technique for obtaining data for a super-area.

The client application can also allow the user to choose the right level of desired privacy. For example, the client may change the size of a submitted super-area so as to generate more or less extraneous data (and more or less privacy). As the above mechanisms show, there may be a trade off between bandwidth usage and location privacy. The higher the need for privacy, the larger should be the size of the selected region. However, this may increase the data communicated between the client and the server.

In one implementation, the data communicated by the traffic alert server is compressed using standard compression techniques to minimize bandwidth requirement. The compression technique used can affect the computation requirement by the client at the mobile device. Depending on the computational capability of the mobile device, it can be advantageous in keeping this computation requirements for decompressing data to a bare minimum.

At 610, the traffic alert system obtains a user-specified privacy preference, which defines the desired level of privacy or granularity. This user-specified privacy preference also determines the size of the super-area, which in turn determines the amount of data that needs to be communicated between the client and the server. Thus, the user-specified privacy preference is a tunable feature that balances between the user's level of privacy and the amount of data handled by the client. For example, if a user does not care about revealing her location privacy, she can set the privacy level at the minimum setting and the processing time by the client can be minimized.

At 615, a pseudo-random region corresponding to the super-area is calculated based on the user-specified privacy preference. In one implementation, the client generates the pseudo-random region by computing the smallest rectangle that encloses the route of interest to the user. This rectangle can then be extended along all four directions. The amount of extension in each of the four directions can be chosen in a pseudo-random fashion.

FIG. 6B shows an example of the super-area based on the rectangular calculation. As shown in FIG. 6B, the super-area 650 includes a broad geographic region that encompasses a good part of the SF Bay area. The route highlighted in blue indicates the actual route of interest 655 to the user, which is a section of Highway 85 between Cupertino and Sunnyvale. The exact location 660 of the user is also depicted in FIG. 6B.

At a later point, if the user travels on the same route again, the client may not generate the rectangle in a completely random fashion. The risk in choosing a completely random super-area each time the user travels on the same route can be that anyone with access to the server can look at user requests over a period of time and compute their intersection to trim down the region that is really of interest to the user.

Once the client application generates a super-area based on a user-specified privacy preference, at 620, the client queries a server for traffic information or GPS-to-road segment ID information. In querying the server, the client communicates the super-area to the server. The server responds with information (e.g., traffic or mapping information) relevant to the super-area. The client then filters information of interest locally on the user's mobile device. The extraneous information provided by the traffic alert server can be cached for later use or simply discarded.

At 625, if the user-specified privacy preference has changed, the random region corresponding to the super-area is recalculated by the client. On the other hand, if the user-specified privacy preference has not changed, then the client continues using the super-area to query up-to-date traffic information from the server. In some implementations, the random region remains fixed, and the only time it would change is when the user travels outside the random region (either because the predicted route was not entirely correct, or because the user decided to take a different route).

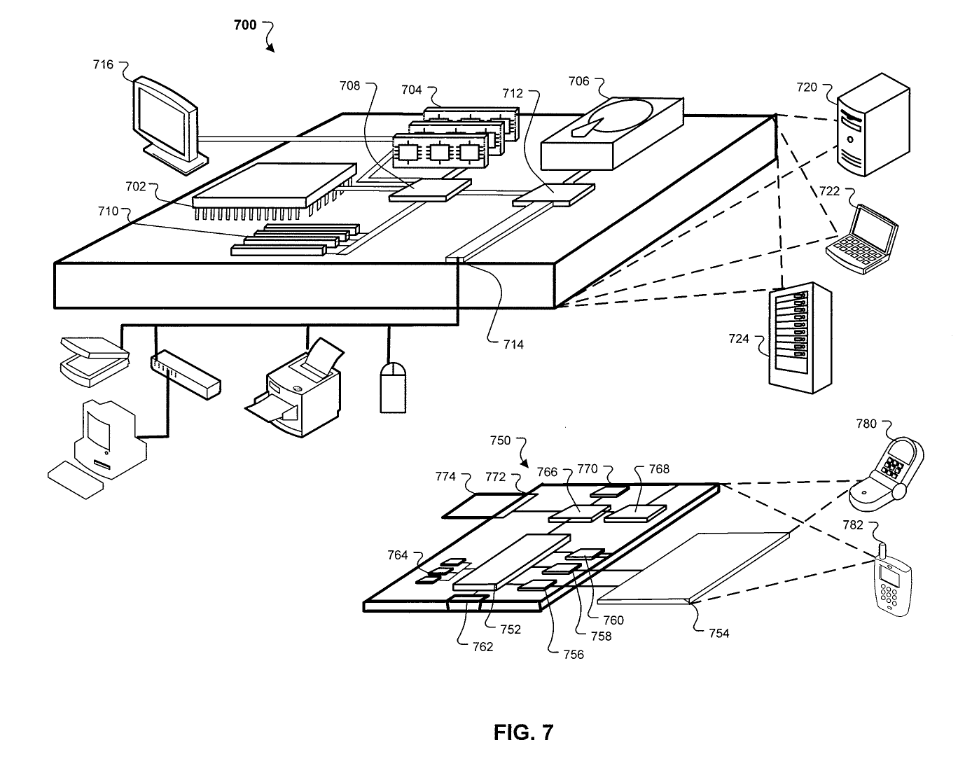

FIG. 7 is a block diagram of computing devices and systems 700, 750. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and can be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses can be used, as appropriate, along with multiple memories and types of memory. Also, multiple computing devices 700 can be connected, with each device providing portions of the necessary operations (e.g., as a server bank, a group of blade servers, or a multi-processor system).

The memory 704 stores information within the computing device 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 can be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which can accept various expansion cards (not shown). In the implementation, low-speed controller 712 is coupled to storage device 706 and low-speed expansion port 714. The low-speed expansion port, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 700 can be implemented in a number of different forms, as shown in the figure. For example, it can be implemented as a standard server 720, or multiple times in a group of such servers. It can also be implemented as part of a rack server system 724. In addition, it can be implemented in a personal computer such as a laptop computer 722. Alternatively, components from computing device 700 can be combined with other components in a mobile device (not shown), such as device 750. Each of such devices can contain one or more of computing device 700, 750, and an entire system can be made up of multiple computing devices 700, 750 communicating with each other.

Computing device 750 includes a processor 752, memory 764, an input/output device such as a display 754, a communication interface 766, and a transceiver 768, among other components. The device 750 can also be provided with a storage device, such as a microdrive or other device, to provide additional storage. Each of the components 750, 752, 764, 754, 766, and 768, are interconnected using various buses, and several of the components can be mounted on a common motherboard or in other manners as appropriate.

The processor 752 can process instructions for execution within the computing device 750, including instructions stored in the memory 764. The processor can also include separate analog and digital processors. The processor can provide, for example, for coordination of the other components of the device 750, such as control of user interfaces, applications run by device 750, and wireless communication by device 750.

Processor 752 can communicate with a user through control interface 758 and display interface 756 coupled to a display 754. The display 754 can be, for example, a TFT LCD display or an OLED display, or other appropriate display technology. The display interface 756 can comprise appropriate circuitry for driving the display 754 to present graphical and other information to a user. The control interface 758 can receive commands from a user and convert them for submission to the processor 752. In addition, an external interface 762 can be provide in communication with processor 752, so as to enable near area communication of device 750 with other devices. External interface 762 can provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 can also be provided and connected to device 750 through expansion interface 772, which can include, for example, a SIMM card interface. Such expansion memory 774 can provide extra storage space for device 750, or can also store applications or other information for device 750. Specifically, expansion memory 774 can include instructions to carry out or supplement the processes described above, and can include secure information also. Thus, for example, expansion memory 774 can be provide as a security module for device 750, and can be programmed with instructions that permit secure use of device 750. In addition, secure applications can be provided via the SIMM cards, along with additional information, such as placing identifying information on the SIMM card in a non-hackable manner.

The memory can include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal.

Device 750 can communicate wirelessly through communication interface 766, which can include digital signal processing circuitry where necessary. Communication interface 766 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 768. In addition, short-range communication can occur, such as using a Bluetooth, WiFi, or other such transceiver (not shown). In addition, GPS receiver module 770 can provide additional wireless data to device 750, which can be used as appropriate by applications running on device 750.

Device 750 can also communication audibly using audio codec 760, which can receive spoken information from a user and convert it to usable digital information. Audio codex 760 can likewise generate audible sound for a user, such as through a speaker, e.g., in a handset of device 750. Such sound can include sound from voice telephone calls, can include recorded sound (e.g., voice messages, music files, etc.) and can also include sound generated by applications operating on device 750.

The computing device 750 can be implemented in a number of different forms, as shown in the figure. For example, it can be implemented as a cellular telephone 780. It can also be implemented as part of a smartphone 782, personal digital assistant, or other similar mobile device.

Where appropriate, the systems and the functional operations described in this specification can be implemented in digital electronic circuitry, or in computer software, firmware, or hardware, including the structural means disclosed in this specification and structural equivalents thereof, or in combinations of them. The techniques can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform the described functions by operating on input data and generating output. The processes and logic flows can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, aspects of the described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications can be made without departing from the spirit and scope of the described implementations. Accordingly, other implementations are within the scope of the following claims.

1. A computer-implemented method, comprising:
obtaining, by a computing device of at least one user, stored route information corresponding to multiple routes of travel taken by the at least one user, wherein:
for a route of travel taken by the at least one user, the computing device gathers corresponding route information, and
the gathered route information is stored at the computing device;
based at least in part on the stored route information, predicting, by the computing device, a current route of travel, including a destination, wherein the destination is predicted based at least in part on one or more of the multiple routes of travel taken by the at least one user;
based on the predicted current route of travel, generating, a super-area of interest, wherein the super-area of interest encompasses all or a portion of the predicted current route of travel and the super-area of interest is larger in geographic area than the encompassed all or a portion of the predicted current route of travel;
submitting, by the computing device to a remote computing system, a request for travel data corresponding to the super-area of interest, wherein, to protect privacy of the at least one user, the request does not identify the location of the computing device, the predicted current route, or portions of the predicted current route;
receiving, from the remote computing system by the computing device in response to the submitted request, travel data corresponding to the super-area of interest;
identifying, from the received travel data corresponding to the super-area of interest and using the computing device, travel data relevant to the predicted current route of travel and removing travel data for the super-area of interest that is not relevant to the predicted current route of travel; and
providing, by the computing device, at least some of the identified relevant travel data to the at least one user of the computing device.

2. The method of claim 0, wherein the request for travel data comprises request for traffic information.

3. The method of claim 0, wherein the super-area of interest comprises a geographic area.

4. The method of claim 0, wherein the super-area of interest is a two-dimensional area.

5. The method of claim 0, wherein the super-area of interest is a geographical area chosen and reconfigurable based on a user-specified privacy setting that defines a desired level of privacy of the user.

6. The method of claim 0, wherein submitting the request for travel data comprises submitting a request for real-time traffic information.

7. The method of claim 0, wherein the computing device is a wireless device running a software application.

8. The method of claim 0, wherein receiving a result corresponding to a super-area that is larger than, but includes, the area of interest comprises receiving traffic alert information by the computing device via a wireless communications link.

9. The method of claim 0, wherein identifying information comprises filtering the result for relevant traffic information associated with the super-area of interest.

10. (canceled)

11. The method of claim 1, wherein the route information corresponding to a travel pattern over a period of time is gathered automatically.

12. (canceled)

13. The method of claim 1, further comprising providing a traffic alert associated with the current route of travel based on the identified information.

14. The method of claim 1, wherein the predicted current route of travel comprises a current location of the computing device and a route from the current location to the predicted destination.

15. (canceled)

16. The method of claim 1, wherein the predicted current route of travel includes a primary route and a secondary route.

17. The method of claim 0, wherein the primary route comprises a route most frequently traveled by a user.

18. The method of claim 0, wherein the secondary route comprises a meaningful alternate route that a user is to take when there is traffic congestion on the primary route.

19. A computing device comprising a computer program product stored on a computer readable medium, the stored computer program product including executable instructions, that if executed by a computing device, causes causing the computing device to perform a method, the method comprising:
obtaining, by a computing device of at least one user, stored route information corresponding to multiple routes of travel taken by the at least one user, wherein:
for a route of travel taken by the at least one user, the computing device gathers corresponding route information, and
the gathered route information is stored at the computing device;
based at least in part on the stored route information, predicting, by the computing device, a current route of travel, including a destination, wherein the destination is predicted based at least in part on one or more of the multiple routes of travel taken by the at least one user;
based on the predicted current route of travel, generating, a super-area of interest, wherein the super-area of interest encompasses all or a portion of the predicted current route of travel and the super-area of interest is larger in geographic area than the encompassed all or a portion of the predicted current route of travel;
submitting, by the computing device to a remote computing system a request for travel data corresponding to the super-area of interest, wherein, to protect privacy of the at least one user, the request does not identify the location of the computing device, the predicted current route, or portions of the predicted current route;
receiving, from the remote computing system by the computing device in response to the submitted request, travel data corresponding to the super-area of interest;
identifying, from the received travel data corresponding to the super-area of interest and using the computing device, travel data relevant to the predicted current route of travel and removing travel data for the super-area of interest that is not relevant to the predicted current route of travel; and
providing, by the computing device, at least some of the identified relevant travel data to the at least one user of the computing device.

20. The stored computer program product of claim 19, wherein the request for travel data comprises request for traffic information.

21. The stored computer program product of claim 19, wherein the super-area of interest comprises a geographic area.

22. The stored computer program product of claim 19, wherein the super-area of interest is a two-dimensional area.

23. The stored computer program product of claim 19, wherein the super-area of interest is a geographical area chosen and reconfigurable based on a user-specified privacy setting that defines a desired level of privacy of the user.

24. The stored computer program product of claim 19, wherein submitting the request for travel data comprises submitting a request for real-time traffic information.

25. The stored computer program product of claim 19, wherein the computing device is a wireless device running a software application.

26. The stored computer program product of claim 19, wherein receiving a result corresponding to a super-area that is larger than, but includes, the area of interest comprises receiving traffic alert information by the computing device via a wireless communications link.

27. The stored computer program product of claim 19, wherein identifying information comprises filtering the result for relevant traffic information associated with the super-area of interest.

28.-29. (canceled)

30. The stored computer program product of claim 19, wherein the route information corresponding to a travel pattern over a period of time is gathered automatically.

31. The stored computer program product of claim 19, further including executable instructions causing the computing device to perform functions comprising:
providing a traffic alert associated with the current route of travel based on the identified information.

32.-33. (canceled)

34. The stored computer program product of claim 19, wherein the predicted current route of travel includes a primary route and a secondary route.

35. The stored computer program product of claim 34, wherein the primary route comprises a route most frequently traveled by a user.

36. The stored computer program product of claim 34, wherein the secondary route comprises one or more meaningful alternate routes that a user takes when there is traffic congestion on the primary route.

37. A personalized traffic alert system comprising:
a computing device having memory, the computing device configured to:
gather route information corresponding to multiple routes of travel of the computing device;
store in memory the route information;
based at least in part on the stored route information, predict a route of travel, including a destination, wherein the destination is predicted based at least in part on one or more of the multiple routes of travel;
generate a super-area of interest that encompasses all or a portion of the predicted route of travel, wherein the super-area of interest is larger in geographic area than the encompassed all or a portion of the predicted current route of travel; and
submit, to a server, a request for data corresponding to the super-area of interest, wherein the request does not identify the location of the computing device, the predicted route of travel, or portions of the predicted route of travel;
the server configured to:
receive a request from the computing device for data corresponding to the super-area of interest; and
provide data for the super-area of interest for the computing device in response to the request;
wherein the computing device is further configured to:
receive, from the server, data for the super-area of interest;
identify, from the received data for the super-area of interest, data relevant to the predicted route of travel; and
provide at least some of the identified relevant data to a user of the computing device.

38. A computer-implemented method, comprising:
obtaining, by a computing device of at least one user, stored route information corresponding to multiple routes of travel taken by the at least one user, wherein:
for a route of travel taken by the at least one user, the computing device gathers corresponding route information, and
the gathered route information is stored at the computing device;
based at least in part on the stored route information, predicting, by the computing device, a current route of travel, including a destination, wherein the destination is predicted based at least in part on time;
based on the predicted current route of travel, generating, a super-area of interest, wherein the super-area of interest encompasses all or a portion of the predicted current route of travel and the super-area of interest is larger in geographic area than the encompassed all or a portion of the predicted current route of travel;
submitting, by the computing device to a remote computing system, a request for travel data corresponding to the super-area of interest, wherein, to protect privacy of the at least one user, the request does not identify the location of the computing device, the predicted current route, or portions of the predicted current route;
receiving, from the remote computing system and by the computing device in response to the submitted request, travel data corresponding to the super-area of interest;
identifying, from the received travel data corresponding to the super-area of interest and using the computing device, travel data relevant to the predicted current route of travel and removing travel data for the super-area of interest that is not relevant to the predicted current route of travel; and
providing, by the computing device, at least some of the identified relevant travel data to the at least one user of the computing device.

39. A computer-implemented method, comprising:
obtaining, by a computing device of at least one user, stored route information corresponding to multiple routes of travel taken by the at least one user, wherein:
for a route of travel taken by the at least one user, the computing device gathers corresponding route information, and
the gathered route information is stored at the computing device;
based at least in part on the stored route information, predicting, by the computing device, a current route of travel, including a destination, wherein the destination is predicted based at least in part on one or more of the multiple routes of travel taken by the at least one user;
based on the predicted current route of travel, generating, a super-area of interest, wherein the super-area of interest encompasses all or a portion of the predicted current route of travel and the super-area of interest is larger in geographic area than the encompassed all or a portion of the predicted current route of travel;
submitting, by the computing device to a computing system, a request for travel data corresponding to at least part of the super-area of interest, wherein, to protect privacy of the at least one user, the request does not identify the location of the computing device;
receiving, from the computing system and by the computing device in response to the submitted request, travel data corresponding to the super-area of interest;
identifying, from the received travel data corresponding to the super-area of interest and using the computing device, travel data relevant to the predicted current route of travel; and
providing, by the computing device, at least some of the identified relevant travel data to the at least one user of the computing device.
